(19) United States
(12) Patent Application Publication
(10) Pub. No.: US 2021/0049169 A1
(43) Pub. Date: Feb. 18, 2021

(54) SYSTEMS AND METHODS FOR TEXT BASED KNOWLEDGE MINING

(71) Applicant: Decooda International, Inc., Atlanta, GA (US)

(72) Inventors: Charles Wardell, Atlanta, GA (US); David Johnson, Atlanta, GA (US); Guru Prasad Venkata Raghavan, Atlanta, GA (US)

(21) Appl. No.: 16/994,189

(22) Filed: Aug. 14, 2020

Related U.S. Application Data
(60) Provisional application No. 62/887,609, filed on Aug. 15, 2019.

(51) Int. Cl. G06F 16/2458

(52) U.S. Cl. CPC G06F 16/2465

(57) ABSTRACT

A method of text based knowledge mining, the method including receiving, by a processing system, a plurality of textual records from one or more data sources and extracting, by the processing system, entities from the plurality of textual records, wherein the entities represent proper nouns in the plurality of textual records. The method further includes extracting, by the processing system, characteristic phrases associated with the one or more entities from the plurality of textual records, determining, by the processing system, topic entities from the entities, wherein the topic entities define a category that one or more of the entities fall within, and performing, by the processing system, a hierarchy analysis to generate hierarchy data based on the entities, the topic entities, and the characteristic phrases.

### CROSS-REFERENCE TO RELATED PATENT APPLICATION

This application claims the benefit of and priority to U.S. Provisional Patent Application No. 62/887,609 filed Aug. 15, 2019, the entirety of which is incorporated by reference herein.

### BACKGROUND

The present application relates generally to computing systems that analyze text data. The present application relates more particularly to extracting information from text data. Some computer systems can be configured to analyze and interpret text data, e.g., unstructured information that is written in a human understandable language. However, in some circumstances, for large data sets of tens or hundreds of thousands of text data entries, it may be difficult for a computing system to properly analyze and make sense of the text data entries. Accordingly, it may be desirable to have systems and methods that allow computing systems to properly analyze and extract information from large data sets.

### SUMMARY

A method of text based knowledge mining including receiving, by a processing system, a plurality of textual records from one or more data sources and extracting, by the processing system, entities from the plurality of textual records, wherein the entities represent proper nouns in the plurality of textual records. The method further including extracting, by the processing system, characteristic phrases associated with the one or more entities from the plurality of textual records, determining, by the processing system, topic entities from the entities, wherein the topic entities define a category that one or more of the entities fall within, and performing, by the processing system, a hierarchy analysis to generate hierarchy data based on the entities, the topic entities, and the characteristic phrases.

In some embodiments, the hierarchy data includes sunburst data representing a sunburst chart. The method further including generating, by the processing system, a user interface including the sunburst chart based on the sunburst data.

In some embodiments, the method further includes determining related entities of the entities by analyzing a knowledge graph, wherein the knowledge graph includes one or more entities and relationships between the one or more entities.

In some embodiments, determining, by the processing system, the topic entities from the entities includes determining a sentiment level for each of the entities and determining the topic entities from the entities based on one or more models and the sentiment level for each of the entities.

In some embodiments, the sentiment level is at least one of a positive sentiment level, a negative sentiment level, or a neutral sentiment level.

In some embodiments, the method further includes extracting, by the processing system, n-grams from the plurality of textual records, wherein the n-grams are each a particular number of co-occurring words in the plurality of textual records, generating, by the processing system, n-gram topics based on the n-grams by determining an influence score of each of the n-grams in the plurality of textual records and setting the n-gram topics to particular n-grams with highest influence scores, determining, by the processing system, similar n-grams of the n-grams, and generating, by the processing system, a user interface including an indication of the n-gram topics and the similar n-grams.

In some embodiments, the method includes determining, by the processing system, the similar n-grams of the n-grams includes performing at least one of a textual similarity analysis or a semantic similarity analysis.

In some embodiments, the method includes determining, by the processing system, the similar n-grams of the n-grams includes determining a similarity score between each of the n-grams.

Another implementation of the present disclosure is a computer system including circuitry, servers, or processors configured to perform receiving a plurality of textual records from one or more data sources, extracting entities from the plurality of textual records, wherein the entities represent proper nouns in the plurality of textual records, extracting characteristic phrases associated with the one or more entities from the plurality of textual records, and determining topic entities from the entities, wherein the topic entities define a category that one or more of the entities fall within. The circuitry, servers, or processors are further configured to perform performing a hierarchy analysis to generate hierarchy data based on the entities, the topic entities, and the characteristic phrases.

In some embodiments, the hierarchy data includes sunburst data representing a sunburst chart. In some embodiments, the circuitry, servers, or processors are configured to perform generating a user interface including the sunburst chart based on the sunburst data.

In some embodiments, the circuitry, servers, or processors configured to perform determining related entities of the entities by analyzing a knowledge graph, wherein the knowledge graph includes one or more entities and relationships between the one or more entities.

In some embodiments, determining the topic entities from the entities includes determining a sentiment level for each of the entities and determining the topic entities from the entities based on one or more models and the sentiment level for each of the entities.

In some embodiments, the sentiment level is at least one of a positive sentiment level, a negative sentiment level, or a neutral sentiment level.

In some embodiments, the circuitry, servers, or processors are configured to perform extracting n-grams from the plurality of textual records, wherein the n-grams are each a particular number of co-occurring words in the plurality of textual records, generating n-gram topics based on the n-grams by determining an influence score of each of the n-grams in the plurality of textual records and setting the n-gram topics to particular n-grams with highest influence scores, determining similar n-grams of the n-grams, and generating a user interface including an indication of the n-gram topics and the similar n-grams.

In some embodiments, determining the similar n-grams of the n-grams includes performing at least one of a textual similarity analysis or a semantic similarity analysis.

In some embodiments, determining the similar n-grams of the n-grams includes determining a similarity score between each of the n-grams.

A non-transient computer readable medium containing instructions, wherein the instructions cause one or more processors to receive a plurality of textual records from one or more data sources and extract entities from the plurality of textual records, wherein the entities represent proper nouns in the plurality of textual records. The instructions cause the one or more processors to extract characteristic phrases associated with the one or more entities from the plurality of textual records, determine topic entities from the entities, wherein the topic entities define a category that one or more of the entities fall within, and perform a hierarchy analysis to generate hierarchy data based on the entities, the topic entities, and the characteristic phrases.

In some embodiments, the hierarchy data includes sunburst data representing a sunburst chart. In some embodiments, the instructions cause the one or more processors to generate a user interface including the sunburst chart based on the sunburst data.

In some embodiments, the instructions cause the one or more processors to determine related entities of the entities by analyzing a knowledge graph, wherein the knowledge graph includes one or more entities and relationships between the one or more entities.

In some embodiments, determining the topic entities from the entities includes determining a sentiment level for each of the entities and determining the topic entities from the entities based on one or more models and the sentiment level for each of the entities.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of knowledge miner configured to extract insights from text data with an n-gram analyzer and an entity analyzer, according to an exemplary embodiment.

FIG. 2 is a block diagram of the n-gram analyzer of FIG. 1 shown in greater detail, according to an exemplary embodiment.

FIG. 3 is a flow diagram of a process of extracting n-grams from text data and identifying similarities between n-grams with the n-gram analyzer of FIGS. 1-2, according to an exemplary embodiment.

FIG. 4 is a block diagram of the entity analyzer of FIG. 1 shown in greater detail, according to an exemplary embodiment.

FIG. 5 is a flow diagram of a process of extracting entities from text data with the entity analyzer of FIGS. 1 and 4, according to an exemplary embodiment.

FIG. 6 is a chart of word embeddings utilized by the n-gram analyzer of FIGS. 1-2, according to an exemplary embodiment.

FIG. 7 is a chart of a knowledge graph utilized by the entity analyzer of FIGS. 1 and 4, according to an exemplary embodiment.

FIG. 8 is a sunburst chart that can be generated by the knowledge miner of FIG. 1, according to an exemplary embodiment.

### DETAILED DESCRIPTION

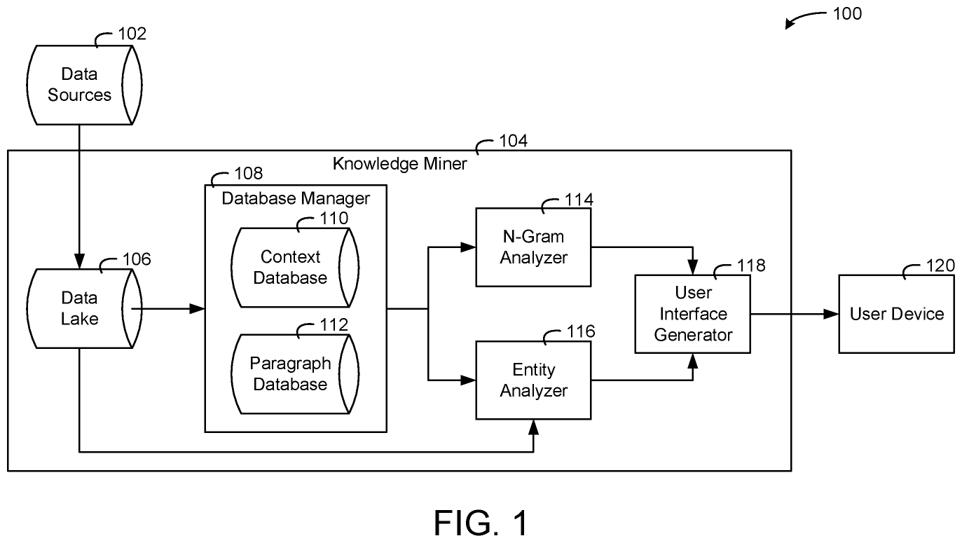

Referring now to FIG. 1, system 100 including a knowledge miner 104 is shown for extracting insights from text data with an n-gram analyzer 114 and an entity analyzer 116, according to an exemplary embodiment. The knowledge miner 104 is configured to receive a large set of text documents and generate granular insights from the text documents, in some embodiments. In some embodiments, the knowledge miner 104 is configured to automatically, or with human-in the loop techniques, generate classification tags based on the insights extracted from the text documents. Classification tags may be indicative of certain categories or act as high level identifiers. In addition to extracting insights, the knowledge miner 104 can generate organization-specific database graphs. These database graphs can be accessed by other applications, for example, question and answer systems, chat-bot systems, etc. Furthermore, the insights extracted from the text can itself be utilized by other software applications, in this regard, the knowledge miner 104 may provide the database graphs to other systems through an application programming interface (API).

The knowledge miner 104 may be one or multiple different computing systems. For example, the knowledge miner 104 may be implemented as software and firmware on one or more servers, one or more desktop computers, handheld devices, etc. In some embodiments, the knowledge miner 104 is built in Scala with the Scala Build Tool (SBT) and/or Jenkins. In some embodiments, the knowledge miner 104 runs on a Windows operating system, an OSX operating system, and/or an Ubunto operating system. In some embodiments, the various components of the knowledge miner 104, i.e., the database manager 108, the n-gram analyzer 114, the entity analyzer 116, the user interface generator 118 or any other sub-components are implemented as microservices and/or operated in a Docker Environment with Kubernetes. In some embodiments, the knowledge miner 104 uses the computing platforms discussed in U.S. Pat. No. 9,727,371 incorporated herein by reference.

The knowledge miner 104 can include one or more processing circuits including memory devices and/or processing devices. For example, the knowledge miner 104 can include, or be executed on, one or more a central processing units (GPUs), one or more graphics processing units (GPUs), one or more application specific integrated circuits (ASICs), one or more field programmable gate arrays (FPGAs), one or more logic circuits, etc. The knowledge miner 104 can be code stored on transitory and/or non-transitory storage mediums, e.g., hard disk drives (HDDs), solid state drives (SSDs), random access memory (RAM), read only memory (ROM), etc.

The knowledge miner 104 is configured to extract insights from data received from data sources 102, in some embodiments. The data sources 102 may provide text based data, e.g., news articles, patent applications, financial reports, stock performance reports, etc. The data sources 102 may provide language (e.g., English, German, French, Chinese, etc.) based information intended for a human reader. As an example, the data sources 102 may be NewsAPI, DowJones, 10K filings to the U.S. Securities and Exchange Commission (SEC), 8K filings to the SEC, and/or any other document source. The data sources 102 may exclude marketing data, personal opinion data, or other data sources that may create noise.

The knowledge miner 104 is configured to receive text data from the data sources 102 and store the data in a data lake 106, in some embodiments. The data lake 106 is configured to provide a raw source of the data collected from the data sources 102. The knowledge miner 104 can include a database manager 108. The database manager 108 is configured to generate and/or maintain a context database 110 and/or a paragraph database 112 based on the data of the data lake 106, in some embodiments.

The database manager 108 is configured to generate the context database 110 based on the data lake 106, in some embodiments. The context database 110 can store abstracted information, in some embodiments. The abstracted information may include broad topics e.g., headlines, quotes, and/or highlighted material of a longer report. The database manager 108 is configured to generate the paragraph database 112 based on the data lake 106, in some embodiments. The paragraph database 112 is configured to store extracted paragraph information, in some embodiments. Each paragraph stored in the paragraph database 112 can be isolated and/or deconstructed into sentences, phrases, and eventually n-grams by the n-gram analyzer 114, in some embodiments.

The paragraphs of the paragraph database 112 may be extracted by the database manager 108 from a document by identifying one or more paragraphs that include a classifier tag. The database manager 108 is configured store a collection of predefined classifier tags and search the document with the classifier tags to identify paragraphs for extraction and storage in the paragraph database 112, in some embodiments. In some embodiments, one or both of the context database 110 and the paragraph database 112 are provided to the n-gram analyzer 114 and/or the entity analyzer 116 for processing and insight extraction, in some embodiments.

The n-gram analyzer 114 is configured to extract n-grams from the data of the context database 110 and/or the paragraph database 112, in some embodiments. Furthermore, the n-gram analyzer 114 is configured identify which n-grams are important and/or which n-grams are similar, in some embodiments. Understanding which n-grams are important for a corpus of data and/or which n-grams are similar can aid a user in selecting classification tags. Furthermore, in some embodiments, the n-gram analyzer 114 itself (e.g., automatically) generates classification tags based on important n-grams and/or similar n-grams. When analyzing the n-grams, the n-gram analyzer 114 is further configured extract and analyzer characteristic phrases, in some embodiments.

An n-gram in text data can be a set of co-occurring words in a text corpus that can reveal powerful information inside the text corpus when the frequencies of these co-occurring words are calculated and the noise removed. For example, “Jon Smith” may be an n-gram of two, i.e., a 2-gram. A similar n-gram may be “Johnathan Smith” another 2-gram. Characteristic phrases in may be a set of co-occurring words similar to n-grams extracted from a text corpus. Unlike n-grams, the characteristic phrases can effectively portray the characteristics surrounding an entity. For example, “William Stevens” may be an entity and an owner of a company that products product A and product B. Phrases related to William Stevens can be “Sales of product A doubled” or “market value of product B reduced triple time low.” These phrases may be characteristic phrases related to William Stevens.

The entity analyzer 116 can be configured to extract entities from the text data of the context database 110 and/or the paragraph database 112. Furthermore, the entity analyzer 116 can identify topical entities and generate an entity hierarchy. For example, “Mobile Device” may be a topical entity while “Laptop Computer” or “Smartphone” could be related entities under the “Mobile Deice” topical entity. An entity can be a proper noun such as person, place, product or organization, etc. An entity can be a proper noun that answers a question such as who, where, which, when, how many, intentions, evidence, etc.

The knowledge miner 104 is configured to extract granular insights of data from a text corpus and/or generate user interface information to represent the insights, in some embodiments. The knowledge miner 104 includes a user interface generator 118. The user interface generator 118 is configured to generate one or multiple different user interfaces representing the insights, in some embodiments. For example, the user interface generator 118 is configured to generate a sunburst graph that provides the insights and relationships between insights to an end user, in some embodiments.

For example, the user interface generator 118 is configured to receive the extracted n-grams and related n-grams and generate a user interface based on the n-grams and related n-grams, in some embodiments. Furthermore, the user interface generator 118 is configured to receive an entity hierarchy and generate a user interface based on the entity hierarchy, in some embodiments. The interface that the user interface generator 118 generates can be displayed on a user device 120. For example, the user device 120 may be a laptop computer, a smartphone, a tablet, etc. The user device 120 can include a user interface for viewing and/or interacting with the interface, e.g., a keyboard, a mouse, a touch screen, a light emitting diode (LED) display, a liquid crystal display (LCD), etc.

In some embodiments, the user interface generator 118 generates a user interface visualizing entities identified by the entity analyzer 116 in an interface box. In some embodiments, the visualizations of the entities may be graphic, e.g., a graph indicating the relationships between the entities. Furthermore, the interface may include n-grams identified by the n-gram analyzer 114 and/or similarities between multiple n-grams. The similarities among n-grams can be included within the interface along with similarity scores identified by the n-gram analyzer 114. In some embodiments the similarity scores may be stored within entity and/or topic graphs. The interface may include a login and the information displayed in the interface may be controlled by user access levels.

Data and textual processing techniques can be found in U.S. patent application Ser. No. 16/293,801 filed Mar. 6, 2019, U.S. patent application Ser. No. 15/640,163 filed Jun. 30, 2017 (now U.S. Pat. No. 10,268,507), U.S. patent application Ser. No. 14/550,798 filed Nov. 21, 2014 (now U.S. Pat. No. 9,727,371), and U.S. patent application Ser. No. 14/304,246 filed Jun. 13, 2014. The entireties of each of these patent applications is incorporated by reference herein. As an example, the parallel processing techniques implemented via a parallel grid as described in U.S. patent application Ser. No. 14/550,798 can be utilized to execute the processing of the knowledge miner 104.

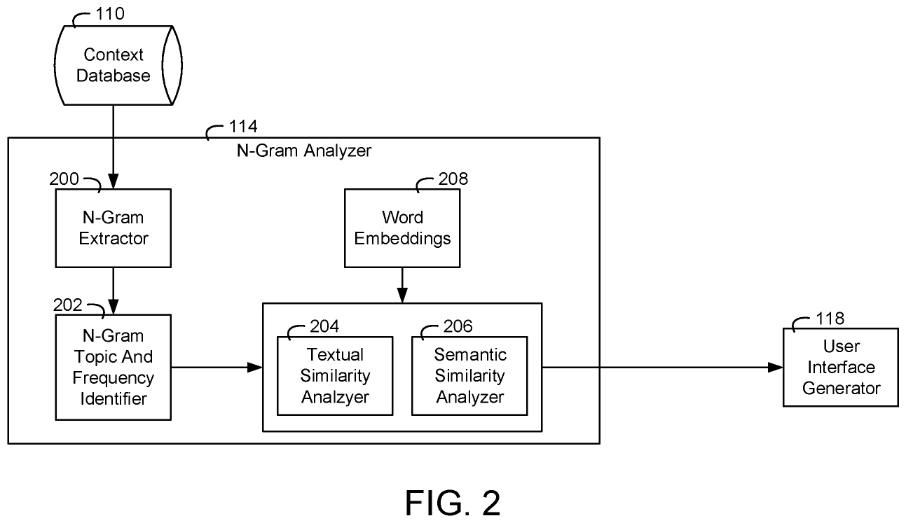

Referring now to FIG. 2, the n-gram analyzer 114 shown in greater detail, according to an exemplary embodiment. The n-gram analyzer 114 includes an n-gram extractor 200, an n-gram topic and frequency identifier 202, word embeddings 208, a textual similarity analyzer 204, and a semantic similarity analyzer 206. The context database 110 is shown to be the input to the n-gram analyzer 114 although in some embodiments, the paragraph database 112 is input, in place of or along with, the context database 110. The context database 110 may include 1,000 records, 100,000 records, or any other number of records where each record is a text document. In some embodiments, the n-gram analyzer 114 includes, or interfaces with, an embedding model. The embedding model is configured, in some embodiments, to generate the word embeddings 208.

In some embodiments, the n-gram analyzer 114 is configured to extract n-grams and other linguistic structures from the context database 110 via the n-gram extractor 200. Furthermore, n-gram topics and n-gram frequencies can be identified by the n-gram analyzer 114 from the extracted n-grams by the n-gram topic and frequency identifier 202. Furthermore, a textual and/or semantic analysis can be performed by the n-gram analyzer 114 on the extracted n-grams to determine similar n-grams via the textual similarity analyzer 204 and/or the semantic similarity analyzer 206. In some embodiments, the n-gram analyzer 114 is configured to generate a graph with the n-gram phrases and/or similarity scores. In some embodiments, the n-gram analyzer 114 determines and/or utilizes an influence score to identify top phrases, i.e., top n-grams. Furthermore, the n-gram analyzer 114 is configured to extract nearest neighbors to acquire triggers and/or build an auto-regex from the nearest neighbors, in some embodiments.

The n-gram extractor 200 is configured to extract n-grams and/or linguistic structures from the text of the context database 110, in some embodiments. Extracting the n-grams and the linguistic structures from the text involves cleaning the text to remove the noise from the data such as Twitter tags, Hypertext Markup Language (HTML) tags, Unicodes, etc. In some embodiments, after being cleaned, the n-gram extractor 200 splits the text into respective unigrams, bi-grams (2-grams), tri-grams (3-grams), and quad-grams (4-grams). In some embodiments, a user provides indications of the n-grams required for processing, i.e., set the value of a maximum value and/or a minimum value for the parameter n.

The n-gram topic and frequency identifier 202 is configured to rank the n-grams and identify characteristic phrases from the n-grams, in some embodiments. The n-gram topic and frequency identifier 202 is configured to determine influence scores for the n-grams extracted by the n-gram extractor 200 and utilize the influence scores to determine characteristic phrases. The influence scores may derived based on how much influence a particular n-gram is having on the whole corpus of text data.

In some embodiments, the n-gram topic and frequency identifier 202 is configured to further rank the n-grams and characteristic phrases with a lexical ranking and/or a page ranking algorithm to provided ranked n-gram and/or characteristic phrases. Lexical ranking involves the sorted dictionary specific ranking of n-grams with all permutations and combinations calculated. The page ranking algorithm can include calculating the importance of a particular n-gram phrase among the whole corpus.

The n-gram topic and frequency identifier 202 is configured to determine influence scores of the n-grams in the whole corpus via the above ranking methodologies. Furthermore, the n-gram topic and frequency identifier 202 can utilize one or more n-gram topic models to detect topics among the n-grams. In some embodiments, the identifier 202 is configured to apply a temporal topic model, in some embodiments. The temporal topic model can be a Discrete-Time Assumption Model, a Dynamic Topic Model, a Compound Topic Model, a continuous-Time Topic Model, a Trend Analysis Model, a Continuous-Time Bayesian Networks, etc. In some embodiments, the identifier 202 is configured to apply an n-gram topic model, e.g., a bigram topic model, an LDA collection model, a topic n-gram model, etc.

In some embodiments, the identifier 202 is configured to perform scaling of the n-grams via map-reduce. In some embodiments, the identifier 202 is a Kafka/Redis process that generates a database and includes an API for querying the database. In some embodiments, the identifier 202 includes a custom part-of speech analyzer.

The textual similarity analyzer 204 can be configured to apply a textual similarity analysis to determine one or more similar n-grams. Furthermore, the semantic similarity analyzer 206 is configured to perform a semantic analysis to identify similar n-grams. The n-grams, along with their similarities, can be provided to the user interface generator 118 for generating a user interface. The similarities may be similarity scores, i.e., a score between a first n-gram and a second n-gram. If the score is greater than a predefined amount, the score may indicate a relationship.

In some embodiments, the textual similarity analyzer 204 applies a string similarity method and/or a knowledge-based similarity method. Examples of string similarity methods may be, Levenshtein Edit Distance, Longest Common Substring, LCS, Jaro, Jaro-Winkler, Needleman-Wunsch, Smith-Waterman, Cosine Similarities, Block Distance, Dice's Coefficient, Euclidean Distance, Jaccard Similarity, Matching Coefficient, Overlap Coefficient etc. The knowledge-based similarity method may be information content based dissimilarity, Resnik's IC method, Lin Methodology, Jiang and Conrath Methodology, Path-length based methodology, etc.

The textual similarity analyzer 204 may be a Kafka/Redis process, the textual similarity analyzer 204 may create a database model and/or database entry based on the result of the similarity analysis. In some embodiments, the textual similarity analyzer 204 include a query API.

The semantic similarity analyzer 206 can be configured to perform Explicit Semantic Analysis, Wordnet-based Conceptual Similarity, Syntactic Dependencies, Information Retrieval Based Similarity, Clustered Keywords Positional Distance, Hyperspace Analogue to Language (HAL), Latent Semantic Analysis, Generalized Latent Semantic Analysis (GSLA), The Cross-Language Explicit Semantic Analysis (CLESA), Pointwise Mutual Information-Information Retrieval (PMI-IR), Second-order Co-occurrence Pointwise mutual information (SCO-PMI), Normalized Google Distance (NGD), Extracting Distributionally Similar Words using Co-occurrences (DISCO), etc. The semantic similarity analyzer 206 can be a Kafka/Redis process and can generate a database model and/or database output. The semantic similarity analyzer 206 can include a query API. The output of the semantic similarity analyzer 206 can be semantic similarities along with the multiple n-grams and/or entities available along with their respective scores. The output can be stored in a database.

In some embodiments, the n-gram analyzer 114 can apply n-gram scaling through a map-reduce feature. In some embodiments, the n-gram analyzer 114 generates a database model with a query API to store the result of the n-gram analysis. In some embodiment, the user interface generator 118 utilize the query API to receive the data of the analysis. In some embodiments, the database model stores the ranked n-grams and/or characteristic phrases.

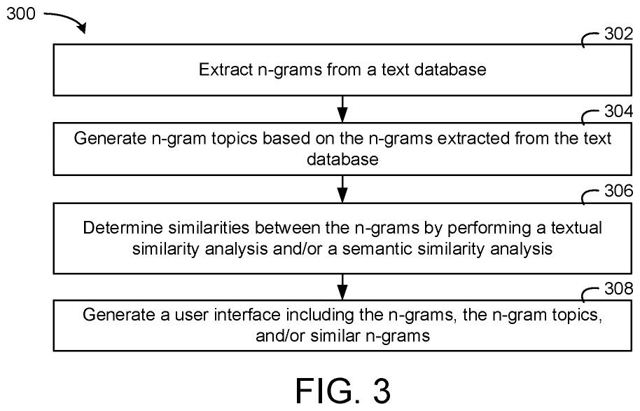

Referring now to FIG. 3, a process 300 of extracting n-grams and identifying similarities from text data is shown, according to an exemplary embodiment. In some embodiments, the n-gram analyzer 114 is configured to perform the process 300. In some embodiments, any computing device described herein is configured to perform the process 300.

In step 302, the n-gram analyzer 114 extracts n-grams from a text database. The n-grams may be bi-grams, tri-grams, quad-grams, and/or any other length n-gram. In some embodiments, the n-gram length may be user defined where n is any integer indicating length. In step 304, the n-gram analyzer 114 can identify n-gram topics. The n-gram analyzer 114 can identify n-grams that are important in the text database. For example, the n-gram analyzer 114 can identify n-gram frequency and/or apply topic models to identify the n-gram topics.

In step 306, the n-gram analyzer 114 can identify similarities between the n-grams. Similar n-grams may be phrases representing the same things. For example, “Jon Smith” and “Johnathan Smith” may be separate n-grams but have a high similarity as both n-grams represent the same person. Similarly, “he is terminated” or “he is fired” may be n-grams representing the same piece of semantic information. The n-gram analyzer 114 can apply a textual analysis and/or a semantic analysis to determine the similarities between n-grams.

In step 308, the n-gram analyzer 114 can generate a user interface based on the n-grams and/or the similar n-grams. The user interface may display topics, phrases, and/or similar phrases. The user interface may allow a user to select category tags and/or generate category tags for certain n-grams and related n-grams. For example, Company A CEO may be a category tag that “Jon Smith” and “Johnathan Smith” fall under.

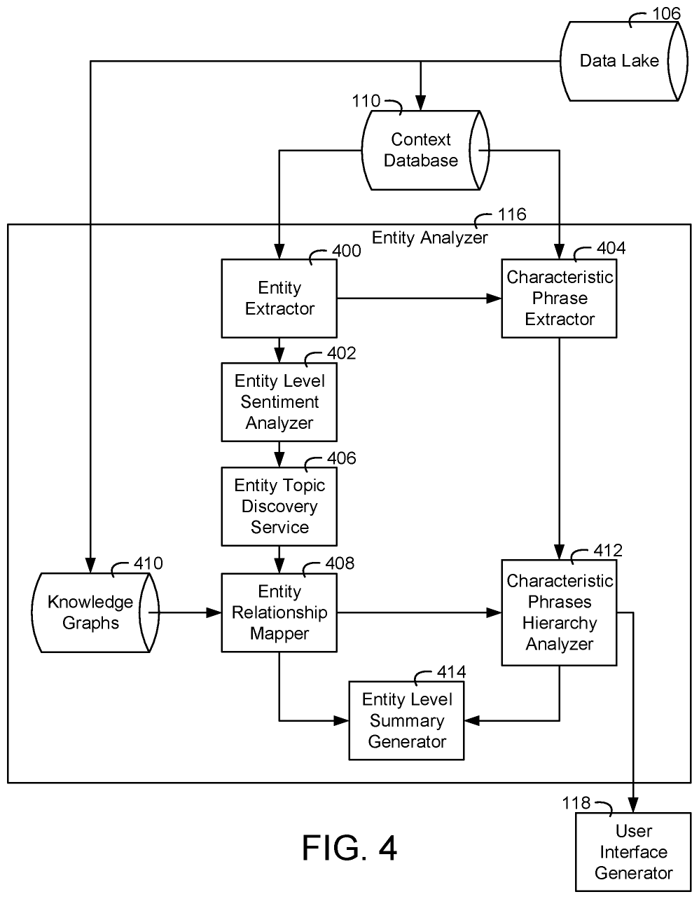

Referring now to FIG. 4, the entity analyzer 116 is shown in greater detail, according to an exemplary embodiment. The entity analyzer 116 includes an entity extractor 400, an entity level sentiment analyzer 402, characteristic phrase extractor 404, an entity topic discovery service 406, an entity relationship mapper 408, knowledge graphs 410, characteristic phrases hierarchy analyzer 412, an entity level summary generator 414. The context database 110 is shown as input into the entity analyzer 116. However, the paragraph database 112 can be input into the entity analyzer 116 instead of, or in addition to, the context database 110. In some embodiments, the input may be 1,000 records, 100,000 records, etc.

The entity extractor 400 is configured to extract entities from the context database 110, in some embodiments. The characteristic phrase extractor 404 is configured to extract characteristic phrases surrounding the entities, in some embodiments. In some embodiments, the entity extractor 400 is configured to determine the occurrence of entities and the characteristic phrase extractor 404 is configured to determine characteristic phrases in the context database 110 for the entities extracted by the entity extractor 400. In some embodiments, the entity extractor 400 is configured to read the data in chunks and validates each chunk to remove empty and non-textual data. In some embodiments, before extracting the entities and characteristic phrases, the entity extractor 400 is configured to clean the text of the context database 110 by stripping the text of spaces, unicode characters, HTML and Twitter tags, and other insignificant strings.

In some embodiments, the entity extractor 400 is configured to tokenize and/or parse the text into entities. In some embodiments, one the entities are extracted, the entity extractor 400 is configured to clean the entities by removing punctuation, removing stop words, removing digits at the beginning of the entities, removing digits at the end of entities, etc. In some embodiments, the entity extractor 400 is configured to place the entities and their value counts into a hash map. In some embodiments, the entity extractor 400 is configured to apply map-reduce to the hash map to merge duplicate entities. In some embodiments, the entity extractor 400 is configured to perform the map-reduce in parallel with other operations.

In some embodiments, the output of the entity extractor 400 is a dictionary of unique entities and/or value counts. In some embodiments, the characteristic phrase extractor 404 is configured to extract the characteristic phrases associated with the extracted entities with a set of linguistic rules and/or machine learning based artificial intelligence (AI) approaches. The linguistic rules may be a set of pattern specific rules related to nouns, verbs, and/or adjectives to extract the phrases associated with those pattern rules from the text. These pattern rules when combined with machine learning models such as Support Vector Machines (SVMs), Decision Trees, Neural Networks, etc. provide an influence scores of the phrases in the text. The characteristic phrase extractor 404 can be configured to set the phrases with the highest influence scores as the characteristics phrases associated with the entities.

In some embodiments, the entity extractor 400 is configured to extract proper nouns such as persons, places, organizations, etc. The entity extractor 400 is configured to perform a rule-based approach to extract the entities, in some embodiments. In some embodiments, the entity extractor 400 is configured to perform a parts of speech based approach to extract the entities. In some embodiments, the entity extractor 400 performs a semantic web-based database approach. In some embodiments, the entity extractor 400 performs a multi-class classification AI approach and/or a conditional random fields approach to extract the entities. In some embodiments, the entity extractor 400 can generate a database of the entities which can be queried through an API of the entity extractor 400. In some embodiments, via a user interface accessed by the user device 120, a user can create and upload data to ingest data into the entity extractor 400 for analysis. In some embodiments, the interface may have options to customize n-gram size, topics, phrases, etc.

The entity level sentiment analyzer 402 is configured to extract sentiment levels for the entities extracted by the entity extractor 400, in some embodiments. The sentiment levels may be positive, negative, or neutral. In some embodiments, the sentiment levels are numerical values. To identify the influence of the entities on the corpus, the entity level sentiment analyzer 402 is configured to determine an entity level sentiment for each entity, in some embodiments. As an example, the sentiment levels for one product identified as an entity in an investment report may be “Product A” while another product, another entity, in the investment report may be “Product B.” The “Product A” entity may be given a −0.36 sentiment level while the “Product B” entity may be given a 0.72 sentiment level.

In some embodiments, the entity level sentiment analyzer 402 is configured to apply a global belief recursive neural network, a hierarchical deep learning methodology, separate aspect sentiment models (e.g., a Bidirectional Recurrent Neural Network (Bi-RNN), a Long-Short Term Memory (LSTM) neural network, a Bidirectional LSTM (Bi-LSTM) neural network, etc.), joint-multi aspect sentiment models (e.g., Bi-RNN, LSTM, Bi-LSTM, etc.). In some embodiments, the entity level sentiment analyzer 402 is configured to perform entity scaling with map-reduce. In some embodiments, the entity level sentiment analyzer 42 is a Kafka/Redis process and/or generates a database that can be queried via an API of the entity level sentiment analyzer 402.

The entity topic discovery service 406 is configured to determine entity topics based on the sentiment levels determined by the entity level sentiment analyzer 402, in some embodiments. In some embodiments, the entity topic discovery service 406 is configured to determine entity topics from the entities with the sentiment scores and various other factors such as eccentricity, centrality, etc., these factors may provide a topic score for each entity. The highest, or a predefined number of the highest topic scored entities, can be assigned entity topics.

In some embodiments, the entity topic discovery service 406 uses the topic scores and models to determine the entity topics associated with a group of entities. The models may be Dirichlet Forest (DF) Latent Dirichlet Allocation (LDA) (DF-LDA) model, and LDA model, a link-LDA model, an author model, an author-topic model, a concept-topic model, a hierarchical concept topic model, GK-LDA, an EntLDA model, and/or a Multi-Domain Prior Knowledge (MDK) Latent Dirichlet Allocation (LDA) (MDK-LDA). The entity that can be associated with the following Entities, “Apple”, “iPad”, “iPhone”, “MacBook” could be assigned a topic entity, i.e., “Apple,” and the remaining “iPad”, “iPhone” and “MacBook” entities would be its associated to the topic entity. The topical entities can be scaled with map-reduce. In some embodiments, the entity topic discovery service 406 is a Kafka/Redis process and/or is configured to generate a database of results. The results can be queried through an API of the entity topic discovery service 406. In some embodiments, via the device 120 a human in the loop can be added for document editing, topic editing, trigger editing, and/or streaming other edits to the back end, i.e., the entity topic discovery service 406.

The entity relationship mapper 408 is configured to link entities to each other using a set of entity relationship mapping processes, in some embodiments. In some embodiments, the entity relationship mapper 408 utilizes a knowledge graph including entities and relationships between entities to determine which entities identified by the entity extractor 400 are related to other entities.

In some embodiments, the mapper 408 is configured to perform automatic content extraction. Automatic content extraction can include Entity Hierarchy, Relation Hierarchy (e.g., Using SVM for Relation Extraction (Explainable AI), Using Bayesian Models for Relation Extraction (Explainable AI), Using Decision Trees for Relation Extraction, etc. The automatic content extraction can include extraction of features for relations hierarchy, word features, etc. In some embodiments, the result of the mapper 408 is stored in a database that can be queried through an API of the mapper 408. In some embodiments, the mapper 408 is configured to batch load graph databases and/or build or provide APIs around the graph databases.

In some embodiments, the mapper 408 is configured to perform dependency-parse based rules, kernel-based machine learning, dependency-parse based feature and SVN, machine learning and rich feature, integrated event extraction, etc. The result of the mapper 408 may be entities arranged with respective relationships to other entities and the scores for each relationship. The output may be stored in a database.

After linking of the entities, the characteristic phrases hierarchy analyzer 412 is configured to perform a hierarchy analysis process, in some embodiments. In some embodiments, the analyzer 412 generates the sunburst data based on the characteristic phrases extracted by the characteristic phrase extractor 404, the topical entities and the other entities related to each topical entity, and the relationships between the various entities determined by the entity relationship mapper 408. The process may generate sunburst data for a sunburst diagram. The result of the analysis may be also be summarized by the entity level summary generator 414 which can be configured to generate textual content associated with an entity or a group of entities. In some embodiments, the generator 414 is configured to generate a corpus summarization, e.g., a domain graph summarization, a sparse summarization, etc. In some embodiments, the corpus summarization is provided in the user interface generated by the user interface generator 118.

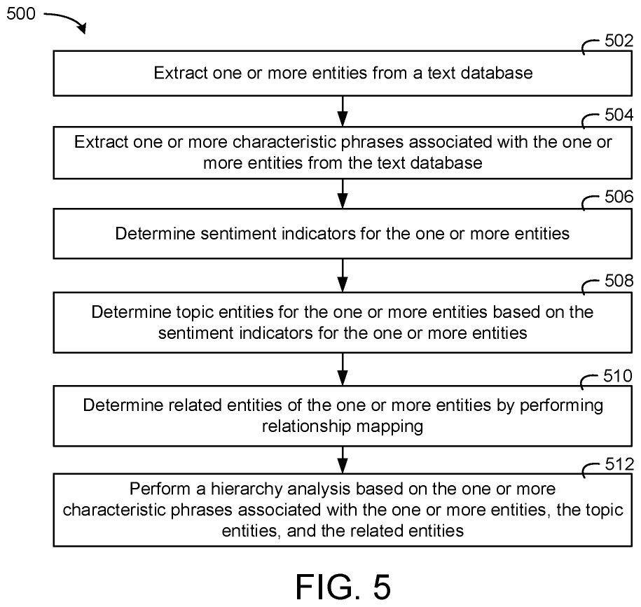

Referring now to FIG. 5, a process 500 of extracting entities from text data with the entity analyzer 116 is shown, according to an exemplary embodiment. In some embodiments, the entity analyzer 116 is configured to perform the process 500. In some embodiments, any computing device described herein is configured to perform the process 500.

In step 502, the entity analyzer 116 can extract one or more entities from a text database. The entities may represent proper nouns, e.g., persons, places, things, etc. The entities may be associated with various characteristic phrases within the text database. In step 504, the entity analyzer 116 extracts on or more characteristic phrases associated with each of the entities from the text database. The entity analyzer 116 can apply various machine learning models and/or linguistic rules to extract the characteristic phrases.

In step 506, for each of the entities, the entity analyzer 116 can determine a sentiment for each of the entities extracted in the step 502. The sentiment may be a positive sentiment, a negative sentiment, or a neutral sentiment. The sentiment may be quantified as a numerical value, in some embodiments. In step 508, based on the sentiment indicators for the one or more entities and/or various models, the entity analyzer 116 can determine topic entities. The topic entities may be entities of the entities extracted in step 502 that are umbrella entities for other entities. For example, “Apple” may be a topic entity while “iPhone” and “iPad” may be entities falling under the topic entity.

In step 510, the entity analyzer 116 determines which of the entities extracted in the step 502 are related. The entity analyzer 116 can determine a relationship value for each combination of the entities. In some embodiments, the entity analyzer 116 utilizes a graph database which indicate relationships between various entities and phrases. In step 512, the entity analyzer 116 determines a hierarchy of the words of the characteristic phrases determined in the step 504 associated with the one or more entities by performing a hierarchy analysis based on the one or more characteristic phrases, the topic entities and the other entities within each topic, and the related entities determine in the step 510.

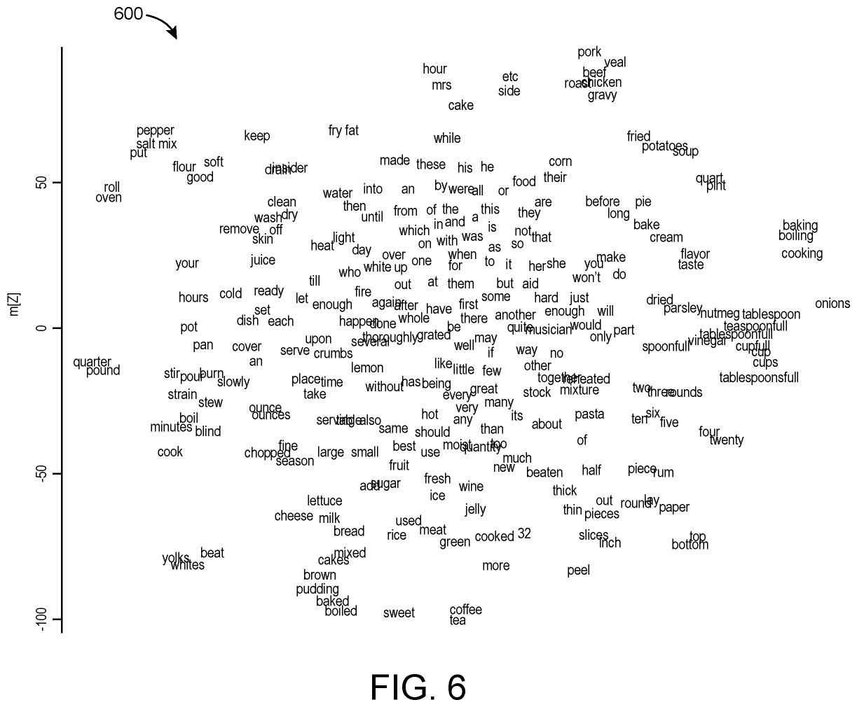

Referring now to FIG. 6 a chart 600 of word embeddings utilized by the n-gram analyzer 114, according to an exemplary embodiment. The chart of word embeddings can be the word embeddings 208. In some embodiments, the chart 600 is generated based on word-2-vec. In some embodiments, the chart 600 is an exemplary chart generated by the user interface generator 118.

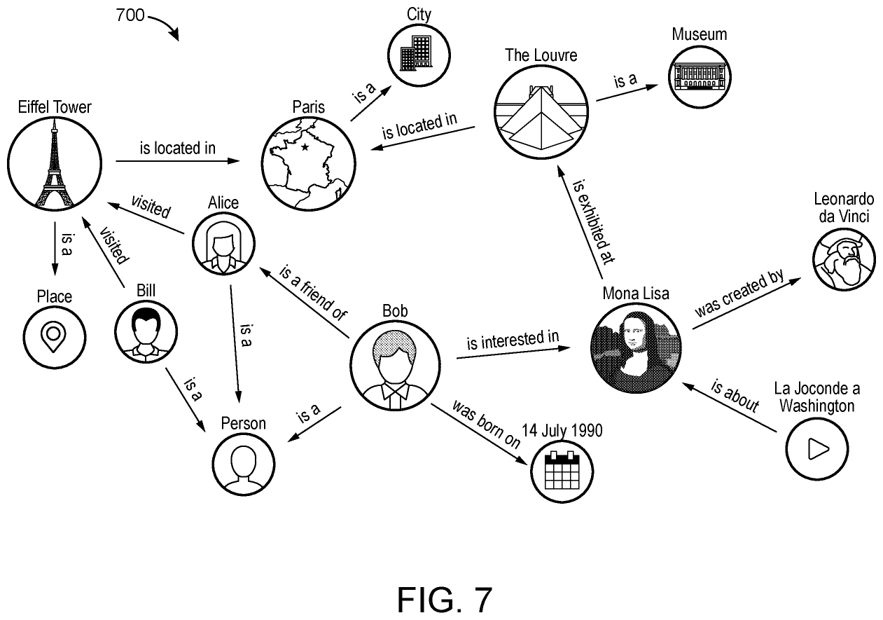

Referring now to FIG. 7, a chart 700 of a knowledge graph utilized by the entity analyzer 116 is shown, according to an exemplary embodiment. The chart 700 includes multiple different entities that represent persons, places, and things. The entities can each have a semantic relationship to other entities. The chart 700 may be a graphical representation of the knowledge graphs 410. In some embodiments, the chart 700 is an exemplary chart generated by the user interface generator 118.

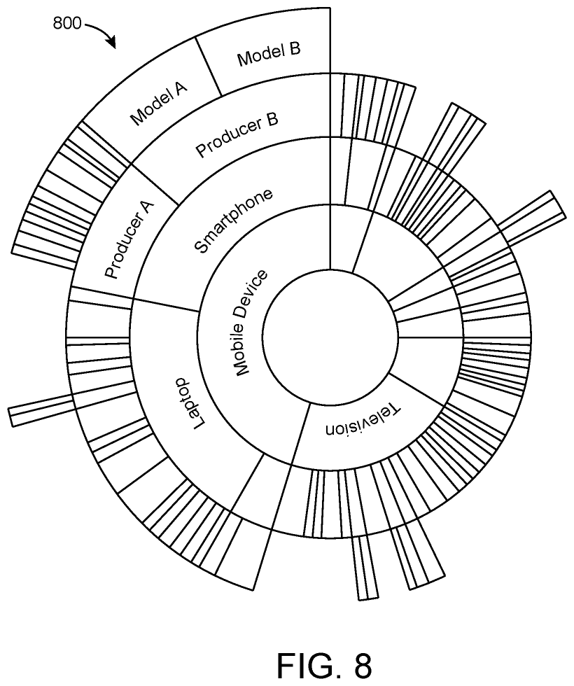

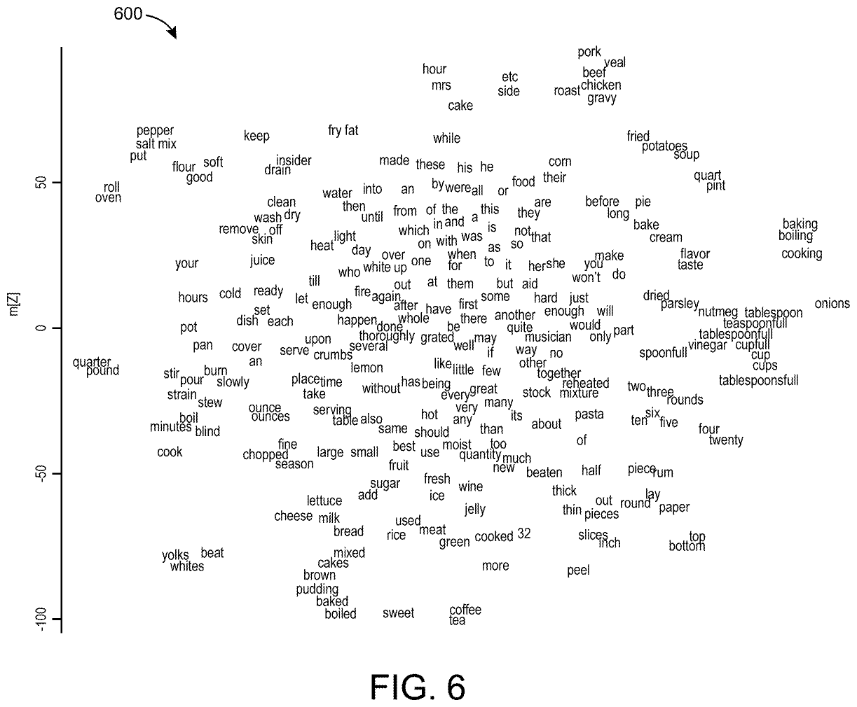

Referring now to FIG. 8 a sunburst chart 800 that can be generated by the user interface generator 118 is shown, according to an exemplary embodiment. The sunburst chart 800 can be displayed on the user device 120, in some embodiments. The chart 800 may be generated based on the hierarchical analysis performed by the analyzer 412. In some embodiment, the chart 800 may represent the characteristic phrases extracted by the characteristic phrase extractor 404. In some embodiments, the chart 800 is an exemplary chart generated by the user interface generator 118.

In the chart 800, a “Mobile Device” may be a topical entity while “Laptop Computer” or “Smartphone” could be related entities under the “Mobile Deice” topical entity. Under the “Smartphone” entity, other related entities may exist in the chart 800, e.g., smartphones of “Producer A” and “Producer B.” Furthermore, entities may exist under the “Producer B” entity, i.e., “Model A” and “Model B” entities.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method of text based knowledge mining, the method comprising:
receiving, by a processing system, a plurality of textual records from one or more data sources;
extracting, by the processing system, entities from the plurality of textual records, wherein the entities represent proper nouns in the plurality of textual records;
extracting, by the processing system, characteristic phrases associated with the one or more entities from the plurality of textual records;
determining, by the processing system, topic entities from the entities, wherein the topic entities define a category that one or more of the entities fall within; and
performing, by the processing system, a hierarchy analysis to generate hierarchy data based on the entities, the topic entities, and the characteristic phrases.

2. The method of claim 1, wherein the hierarchy data comprises sunburst data representing a sunburst chart;
wherein the method further comprises generating, by the processing system, a user interface comprising the sunburst chart based on the sunburst data.

3. The method of claim 1, wherein the method further comprises determining related entities of the entities by analyzing a knowledge graph, wherein the knowledge graph comprises one or more entities and relationships between the one or more entities.

4. The method of claim 1, wherein determining, by the processing system, the topic entities from the entities comprises:
determining a sentiment level for each of the entities; and
determining the topic entities from the entities based on one or more models and the sentiment level for each of the entities.

5. The method of claim 4, wherein the sentiment level is at least one of a positive sentiment level, a negative sentiment level, or a neutral sentiment level.

6. The method of claim 1, the method further comprising:
extracting, by the processing system, n-grams from the plurality of textual records, wherein the n-grams are each a particular number of co-occurring words in the plurality of textual records;
generating, by the processing system, n-gram topics based on the n-grams by determining an influence score of each of the n-grams in the plurality of textual records and setting the n-gram topics to particular n-grams with highest influence scores;
determining, by the processing system, similar n-grams of the n-grams; and
generating, by the processing system, a user interface comprising an indication of the n-gram topics and the similar n-grams.

7. The method of claim 6, wherein determining, by the processing system, the similar n-grams of the n-grams comprises performing at least one of a textual similarity analysis or a semantic similarity analysis.

8. The method of claim 6, wherein determining, by the processing system, the similar n-grams of the n-grams comprises determining a similarity score between each of the n-grams.

9. A computer system including circuitry, servers, or processors configured to perform:
receiving a plurality of textual records from one or more data sources;
extracting entities from the plurality of textual records, wherein the entities represent proper nouns in the plurality of textual records;
extracting characteristic phrases associated with the one or more entities from the plurality of textual records;
determining topic entities from the entities, wherein the topic entities define a category that one or more of the entities fall within; and
performing a hierarchy analysis to generate hierarchy data based on the entities, the topic entities, and the characteristic phrases.

10. The computer system of claim 9, wherein the hierarchy data comprises sunburst data representing a sunburst chart;
wherein the circuitry, servers, or processors are configured to perform generating a user interface comprising the sunburst chart based on the sunburst data.

11. The computer system of claim 9, wherein the circuitry, servers, or processors configured to perform determining related entities of the entities by analyzing a knowledge graph, wherein the knowledge graph comprises one or more entities and relationships between the one or more entities.

12. The computer system of claim 9, wherein determining the topic entities from the entities comprises:
determining a sentiment level for each of the entities; and
determining the topic entities from the entities based on one or more models and the sentiment level for each of the entities.

13. The computer system of claim 12, wherein the sentiment level is at least one of a positive sentiment level, a negative sentiment level, or a neutral sentiment level.

14. The computer system of claim 9, wherein the circuitry, servers, or processors are configured to perform:
extracting n-grams from the plurality of textual records, wherein the n-grams are each a particular number of co-occurring words in the plurality of textual records;
generating n-gram topics based on the n-grams by determining an influence score of each of the n-grams in the plurality of textual records and setting the n-gram topics to particular n-grams with highest influence scores;
determining similar n-grams of the n-grams; and
generating a user interface comprising an indication of the n-gram topics and the similar n-grams.

15. The computer system of claim 14, wherein determining the similar n-grams of the n-grams comprises performing at least one of a textual similarity analysis or a semantic similarity analysis.

16. The computer system of claim 14, wherein determining the similar n-grams of the n-grams comprises determining a similarity score between each of the n-grams.

17. A non-transient computer readable medium containing instructions, wherein the instructions cause one or more processors to:
receive a plurality of textual records from one or more data sources;
extract entities from the plurality of textual records, wherein the entities represent proper nouns in the plurality of textual records;
extract characteristic phrases associated with the one or more entities from the plurality of textual records;
determine topic entities from the entities, wherein the topic entities define a category that one or more of the entities fall within; and
perform a hierarchy analysis to generate hierarchy data based on the entities, the topic entities, and the characteristic phrases.

18. The non-transient computer readable medium of claim 17, wherein the hierarchy data comprises sunburst data representing a sunburst chart;
wherein the instructions cause the one or more processors to generate a user interface comprising the sunburst chart based on the sunburst data.

19. The non-transient computer readable medium of claim 17, wherein the instructions cause the one or more processors to determine related entities of the entities by analyzing a knowledge graph, wherein the knowledge graph comprises one or more entities and relationships between the one or more entities.

20. The non-transient computer readable medium of claim 17, wherein determining the topic entities from the entities comprises:
determining a sentiment level for each of the entities; and
determining the topic entities from the entities based on one or more models and the sentiment level for each of the entities.
